(19) United States
(12) Patent Application Publication
(10) Pub. No.: US 2023/0271353 A1
(43) Pub. Date: Aug. 31, 2023

(54) METHOD FOR PRODUCING MOULDED PARTS, IN PARTICULAR DENTAL MOULDED PARTS

(71) Applicant: WDT-WOLZ-DENTAL-TECHNIK GMBH, Bad Sobenheim (DE)

(72) Inventor: Stefan Wolz, Bad Sobernheim (DE)

(21) Appl. No.: 17/769,026

(22) PCT Filed: Oct. 20, 2020
(86) PCT No.: PCT/EP2020/079503

§ 371 Date: Feb. 14, 2023

(30) Foreign Application Priority Data
Oct. 21, 2019 (DE) 10 2019 128 336.1

(51) Int. Cl. B29C 33/38; B29C 64/393; B29C 64/165

(52) U.S. Cl. CPC B29C 33/3842; B29C 64/393; B29C 64/165; B33Y 10/00

(57) ABSTRACT

A method for producing molded parts from a sinterable mixing compound using a cold casting mold having a cavity that corresponds geometrically to the molded part and at least one opening into the cavity, wherein the mold is additively constructed from a starting material, in particular a 3D printing method using a 3D printer, and wherein the cavity is created on the basis of a digital data set, in particular based on a three-dimensional model of the oral cavity of a patient. The cavity is filled via the opening with the sinterable mixing compound, curing and/or solidifying the mixing compound, wherein gases and/or liquids contained in the mixing compound are discharged from the cavity via the opening, thermally and/or thermochemically decomposing the mold at a temperature from 200° C. to 2500° C. and sintering the mixing compound to hardness at a temperature from 900° C. to 2500° C. until a molded part is obtained.

### BACKGROUND OF THE INVENTION

The invention relates to a method for producing molded parts, in particular dental molded parts, from a sinterable mixing compound using a cold casting mold having a cavity that corresponds geometrically to the molded part, in particular dental molded part, and at least one opening opening into the cavity, wherein the cold casting mold is additively constructed from a starting material by means of an additive material construction method, in particular a 3D printing method using a 3D printer, and wherein the cavity is created on the basis of a digital data set, in particular based on a three-dimensional model of the oral cavity of a patient.

The production of molded parts by means of computer-assisted methods (CAD/CAM) is known from a large number of technical fields. Dental molded parts, in particular dentures, such as crowns and bridges, but also dental implants and prostheses or parts relevant to orthodontics, such as brackets, are manufactured in many dental practices and dental laboratories by computer-assisted methods (CAD/CAM). First, a digital, three-dimensional model of the oral cavity of a patient is created. The required dentures are planned with the aid of software and the created data set is transferred to a milling machine, for example, which mills the finished dentures out of a blank. The blanks are usually produced according to a cold casting process, in which a mixing compound is first produced from a ceramic powder or metal powder suitable for dental technology. A pasty mass, a slurry, a suspension, or even a “dry” bulk powder can be used as the mixing compound. A method for producing dentures from dental metal powder is known from EP 2 470 113 B1. In this case, a CrCo dental metal powder is mixed into a slurry, poured cold into a mold, and dried therein. A binder added to the slurry provides sufficient dimensional stability after the drying, so that the dried slurry can be removed from the cold casting mold as a green body and milled into the desired three-dimensional shape using the transferred digital data set. Final (dense) sintering gives the dentures the required hardness and density. Material properties required for approval as dental molded parts are permanently defined on the basis of national and/or international standards. Such cold casting methods are only suitable for the production of blanks. The fine, complex shapes of the actual dentures are then milled out of the blank by machining. Teachings on metal or ceramic slurries for dental technology are prior art and can be found, for example, in the documents EP1658018 B1, EP1047355 B1, WO 2013007684 A, EP1558170 B1, and EP1885278 B1. Information on their conditioning can be found in the documents DE 10 2005 023 727 B4 and DE19801534 A1. Carrying out the ultimate dense or final sintering is also adequately described in the prior art; corresponding methods and sintering furnaces can be found in EP 2765950 B1, EP 2844412 A1, WO2011020688 A1.

When using bulk powders as a mixing compound, an additional work step, carrying out isostatic pressing, is usually required to achieve sufficient dimensional stability. High pressure is applied evenly to all sides of the mixing compound for this purpose. Corresponding methods for the production of ceramic dentures from ceramic powders, for example, zirconium oxide are also well known from the prior art. A method in which tooth parts are produced from ceramic powder is described in WO 2008/114 142 A1.

The digital, three-dimensional model of the oral cavity is also used for the production of temporary restorations made of plastic. Here, the data set created for the denture is passed on a 3D printer, which constructs the temporary restoration in layers by means of an additive material construction method (3D printing) from plastic starting material.

In the meantime, in addition to plastics, inorganic substances can also be used as starting materials in the field of additive material construction methods. Additive material construction methods such as SLM (selective laser melting), extrusion methods such as FDM (fused deposition molding) and FFF (fused filament fabrication) are known. Additive material construction methods that use the light-curing properties of the starting materials are also known, e.g.: SLA or STL (stereolithography), DLP (digital light processing), LCM (lithography-based ceramic manufacturing).

There have therefore already been initial attempts to produce dentures from metal or ceramic by means of additive material construction methods. A method in which a tooth crown is produced from zirconia by means of an additive material construction method is known from WO 2018/065856 A1. However, 3D printers for metal or ceramic objects are very expensive and/or the printed molded part does not meet the high material requirements to be approved for dental use. In particular, additive material construction methods require a very high proportion of binder in the starting material (approximately 30%), which is why the required final density or final hardness cannot be achieved or is extremely difficult to achieve. An economical implementation of the printing of dental molded parts made of ceramic or metal is not in sight.

WO 2019/210285 A2 discloses another possibility in which the digital, three-dimensional data of the oral cavity is to be used to produce densely sintered dental prostheses with a complex shape using a 3D printer. For this purpose, not the dentures, but a self-destructing casting mold is to be printed by means of a 3D printer. A powder mixture made of two components, a sinterable alumina powder and a powdered binder having a high coefficient of thermal expansion (CTE), is used as the starting material for the printing process. The printed casting mold is filled with a sinterable, dry zirconia bulk powder as a mixing compound. The casting mold is then closed using a cover printed from the same material in order to isostatically press the (two-part) casting mold together with the zirconia bulk powder located therein at a pressure of 400 MPa. In this method, it is crucial that the bulk powder is free of binders in order to enable uniform pressing. The bulk powder is compacted together with the casting mold and then sintered without removing the mold. During sintering, the binders contained in the mold expand, causing the mold to burst open. The sintering temperature of the mold has to be higher than the sintering temperature of the bulk powder so that the finished sintered molded part is released from the mold. A disadvantage of the disclosed method is, on the one hand, the high costs associated with the 3D printing of the ceramic starting material and the isostatic pressing at extremely high pressures of 400 MPa. However, the use of a ceramic starting material having a sintering temperature higher than that of the bulk powder is crucial for the method described. On the other hand, the possible uses of the method are also limited. The mixing compound used has to be free of binders in order to achieve uniform pressing. In addition, compacting pressing methods, especially isostatic pressing, in which the pressure is to act evenly on the molded part from all sides, are not suitable for mixing compounds having a moisture content of greater than 7%. Liquids are nearly incompressible. To carry out the isostatic pressing, it is necessary to completely enclose the bulk powder within the casting mold closed using the lid. For this reason, any moisture contained in the mixing compound cannot escape.

The object of the present invention is therefore to provide an additively constructed, in particular 3D-printed cold casting mold which, in comparison to the prior art, is more cost-effective and enables mass production of dental molded parts having complicated anatomical shapes, such as crowns, bridges, jaw implants, abutments, prostheses, etc. At the same time, the possible uses are to be expanded. In particular, the use of a wide variety of mixing compounds made of sinterable metallic and/or ceramic materials, either in dry powder form or as a slurry, suspension, or pasty mass, is made possible.

### SUMMARY OF THE INVENTION

A method for producing a molded part, in particular a dental molded part, of the type described in detail at the outset is characterized by the following method steps:
filling the cavity of the cold casting mold via the at least one opening with the sinterable mixing compound,
curing and/or solidifying the sinterable mixing compound in the cavity of the cold casting mold, wherein gases and/or liquids contained and/or enclosed in the sinterable mixing compound are discharged from the cavity via the at least one opening,
thermally and/or thermochemically decomposing the cold casting mold at a temperature in a temperature range from 200° C. to 2500° C.,
sintering the sinterable mixing compound to final hardness at a temperature in a temperature range from 900° C. to 2500° C. until a molded part, in particular a dental molded part, such as a denture is obtained.

According to the invention, it is therefore provided that an additively constructed, preferably 3-D printed, and preferably integral cold casting mold be used for producing molded parts, in particular dental molded parts, which mold may preferably be decomposed by pyrolysis or combustion or dissolved in one work step, during sintering of the mixing compound to form the finished molded part, in particular dental molded part. In this way, damage to the dental molded part, which often has filigree structures having small wall thicknesses, due to breaking or bursting open of the cold casting mold or other forces acting on it can be avoided. After completion of the sintering, the cold casting mold is completely or almost completely decomposed thermally or thermochemically, so that an additional work step in which the cold casting mold and the molded part would have to be separated from one another is avoided.

According to the method according to the invention, the cavity of the cold casting mold is filled with the sinterable mixing compound, preferably after its completion, optionally under the action of pressure, and cures in the cold casting mold or solidifies in its interior. In particular during the filling and/or during the curing or solidifying, but also during the entire course of the method, gases and/or liquids contained and/or enclosed in the mixing compound can be discharged or escape from the cavity via the at least one opening. Expediently, the at least one opening likewise remains unsealed or open during the entire course of the method for this purpose.

The thermal and/or thermochemical decomposition of the cold casting mold can already be initiated during the curing or solidifying of the mixing compound, or alternatively only after the mixing compound has cured completely, in particular to green body hardness. Preferably, the decomposition starts in a temperature range from 200° C. to 650° C. and is completed during final sintering at a temperature in a temperature range from 900° C. to 2500° C.

The curing or solidifying of the mixing compound in the cavity can take place in different ways, in particular by chemical reaction. The chemical reaction can be implemented in particular by means of a binder or two-component binder. Depending on the choice of binder, the reaction can be started by different triggers, for example by irradiation using a light source, in particular a UV source, by the action of heat, by withdrawal of moisture, etc.

According to an advantageous variant of the method, the mixing compound is provided as a slurry and/or pasty mass and comprises a diluent, in particular water, wherein the mixing compound cures and/or solidifies in the cavity of the cold casting mold by drying and a liquid component and/or moisture content of the mixing compound is discharged by means of the at least one opening from the cold casting mold, in particular is withdrawn from the mixing compound.

Especially when using slurries or moist/pasty masses as a mixing compound, but also for bulk powders, the cold casting mold is, according to one advantageous embodiment of the method, additively constructed having at least one first opening opening into the cavity and/or leading out of the cavity and having at least one second opening opening into the cavity and/or leading out of the cavity, wherein the cavity of the cold casting mold is filled via the first opening and gases contained and/or enclosed in the sinterable mixing compound, in particular air inclusions, and/or liquids, in particular diluents, are discharged via the second opening from the cavity.

In addition to the at least one first opening, which is provided for filling the cavity with the mixing compound, at least one second opening can therefore be formed, which is then provided for discharging fluids contained in the mixing compound. In principle, it is conceivable to form the first opening and/or the second opening, in particular to drill it, after the additive construction of the cold casting mold has been completed. However, it is advantageous to form the first opening and/or the second opening directly during the additive material construction, so that an additional work step is avoided. Due to the formation of the at least one second opening, the cold casting mold constructed additively according to the method according to the invention can not only be used for mixing compound having any moisture content, the at least one second opening also allows venting when using a bulk powder, which can be assisted, for example, by shaking. In a refinement of this embodiment, at least one wall of the cold casting mold that delimits the cavity is therefore completely or in regions additively constructed having a plurality of second openings that open into the cavity and penetrate this wall, for discharging gases, in particular air inclusions, and/or liquids, in particular diluents.

In that one or more walls of the cold casting mold are penetrated with a plurality of second openings adjacent to one another, a sieve-like surface may be formed which, on the one hand, enables the passage of liquids and gases, but on the other hand holds back solids. The diameter of the respective second openings is preferably smaller than the particle size and/or the size of particle agglomerates that form in the powder contained in the mixing compound, such as metal powder, ceramic powder, or glass ceramic powder. The plurality of second openings can therefore also be formed as pores and/or capillaries which penetrate the wall, so that the wall has porous and/or hygroscopic properties, completely or in regions.

Such an embodiment also has the advantage that moisture contained in the mixing compound is taken up or absorbed by the adjoining porous and/or hygroscopic wall and is preferably transported away from the interior, in the direction of the atmosphere surrounding the cold casting mold or away. This effect can be aided by increasing the ambient temperature surrounding the cold casting mold or other measures to reduce the ambient humidity, by which drier ambient air is created.

A method variant therefore provides that the mixing compound cures and/or solidifies in the cavity of the cold casting mold under the action of heat, wherein the cold casting mold filled with the mixing compound is placed in a drying cabinet or a sintering furnace and a temperature in a temperature range from 30° C. to 120° C. is set. If necessary, the ambient humidity of the environment can also be set to a desired value. Ambient humidity in a range from 1% to at most 50% has proven to be advantageous for gentle, uniform, and at the same time rapid drying.

The action of heat and, if necessary, reduced humidity can accelerate the curing of the mixing compound, for example in the case of a drying process. In particular, the atmosphere or ambient air present in the environment, i.e., in the drying cabinet or climatic cabinet or in the sintering furnace, is dried, as a result of which moisture and/or liquid contained in the mixing compound are transported away more quickly from the cavity to the environment. This effect can have considerable influence on the drying times, especially when the walls of the cold casting mold are designed having a porous and/or hygroscopic surface which is penetrated by a large number of second openings in the form of pores and/or capillaries.

Volume shrinkage or sintering shrinkage of the molded part usually occurs both during curing and/or solidifying of the mixing compound and during sintering, which is caused by the compaction of the mixing compound. The digital data set, which is based on a three-dimensional model of the oral cavity of a patient, for the geometric design of the cavity of the cold casting mold therefore preferably includes a sintering-related and/or curing-related volume shrinkage of the mixing compound.

Depending on the mixing compound used, a corresponding volume shrinkage during curing and/or sintering of the mixing compound is to be taken into consideration, the cavity of the cold casting mold is to be designed having a correspondingly adapted (larger) initial geometry. For example, for mixing compounds containing ceramic powder, sintering shrinkage in a range from 25% to 50%, for mixing compounds containing sol and nano zirconium oxide particles in a range from 50% to 95% and for mixing compounds containing metal powder, sintering shrinkage in a range from 8% to 25% is to be taken into consideration, each in relation to the initial geometry. For the curing of the mixing compound by light and/or drying, volume shrinkage of approximately 2% to 20% in relation to the initial geometry is to be taken into consideration. A volume shrinkage in a range from 1% to 10%, in relation to the initial geometry, can also be taken into consideration for the cold casting mold itself for the production of the molded part. The cold casting mold produced according to the method according to the invention enables molded parts, in particular dental molded parts, to be produced cost-effectively from a wide variety of mixing compounds.

In order to ensure that there is always sufficient mixing compound available for producing the molded part, in particular a dental molded part, in particular when volume shrinkage occurs, in one refinement, at least one compensating volume is connected to the cavity of the cold casting mold in a fluid-conducting manner, if necessary via a filling channel, for storing mixing compound. The compensating volume is preferably also additively constructed integrally with the cold casting mold. In particular when using mixing compound having a higher moisture content and/or in the case of air inclusions, the compensating volume acts as a kind of reservoir and allows the mixing compound to run or trickle down to compensate for the volume loss caused by the escape of gases and/or liquids via the at least one second opening from the cavity.

It is advantageous for the method if an organic material, in particular an organic polymer, a wax, or a plastic, preferably having a melting point or a decomposition temperature in a temperature range from 40° C. to 300° C., is used as the starting material for additively constructing the cold casting mold, so that the cold casting mold can be plasticized and/or thermally and/or thermochemically decomposed. A material group having a particularly low heat resistance is represented, for example, by waxes. By using a waxy, organic material, a softening or plasticizing of the cold casting mold can already be achieved from a temperature of approximately 35° C.

Organic materials such as waxes and/or polymers and/or plastics are significantly easier and therefore more cost-effective to use in additive material construction methods, for example 3-D printing. The heat resistance of plastics is comparatively low, so that the additively constructed cold casting mold made of an organic material can be plasticized or even decomposed thermally and/or thermochemically, in particular by pyrolysis and/or combustion. For structures and/or walls of the cold casting mold that do not delimit or directly adjoin the cavity, in particular for support structures, filling channels, compensating volumes, etc., a starting material having a lower melting point, for example, wax, can advantageously be used than for the walls of the cold casting mold that delimit the cavity, which are then additively constructed, for example, from polymers or plastics. In this way, during the plasticizing or decomposition of the cold casting mold, in particular stresses occurring as a result of heat, which could result in damage to the molded part, can be reduced or even completely avoided. Other properties of the cold casting mold, such as water solubility, color, transparency, etc., can also be embodied differing from one another in different regions by additive construction, in particular 3D printing using different starting materials. The organic starting material can contain small additions of inorganic materials. For example, it is common to admix inorganic additives to plastics. However, the proportion of organic components is always higher than the proportion of inorganic components.

According to a preferred method design, the mixing compound comprises a metal powder, in particular a CrCo powder, or a ceramic powder, in particular an aluminum oxide powder and/or a zirconium oxide powder, and/or a glass ceramic powder, in particular a lithium disilicate powder, and a binder.

Mixing compounds containing binders can be cured in the cold casting mold solely by drying, without pressure being applied, in particular to green body harness. The use of a binder means that the cost-intensive isostatic pressing known from the prior art can be dispensed with. In contrast to the method also described in the prior art, however, it is then necessary to carry out the curing of the mixing compound with the cold casting mold open (without a “lid”), so that fluids are discharged from the cavity of the cold casting mold via the at least one opening. Binders are known in many forms from the prior art and consist mainly of organic materials such as resins, surfactants, and/or waxes, which result in a comparatively low melting point.

In order to achieve a gentle detachment of the cold casting mold from the mixing compound before debinding takes place or before the binder begins to melt, according to a variant of the method, the temperature resistance and/or heat resistance of the cold casting mold, in particular the melting point and/or the decomposition temperature of the cold casting mold, is below the melting point of the binder and/or below the sintering temperature of the mixing compound, in particular of the metal powder or the ceramic powder.

The mixing compound thus preferably cures, in particular even to green body hardness, in the cavity of the cold casting mold before the decomposition of the cold casting mold is initiated or completely carried out.

According to one method design, the decomposition of the cold casting mold can be initiated or carried out completely by the action of heat at a temperature in a temperature range from 200° C. to 650° C., before the mixing compound is sintered to final hardness.

For this purpose, the melting point and/or the decomposition temperature of the cold casting mold can expediently be below the sintering temperature of the metal powder or the ceramic powder.

One refinement of the method provides that the organic material used for additively constructing the cold casting mold is first plasticized by the action of heat at a temperature in a temperature range from 35° C. to 300° C. and is decomposed thermally by pyrolysis and/or thermochemically by combustion at a temperature in a temperature range from 200° C. to 650° C.

In order to facilitate detachment of the walls delimiting the cavity from the mixing compound located therein, the cold casting mold filled with the mixing compound is placed in a drying cabinet or climatic cabinet or a sintering furnace and a temperature is set in a temperature range from 35° C. to 300° C. The material properties of organic materials or plastics can be utilized here. Before the melting point of the cold casting mold is reached, the organic material, in particular the plastic, begins to soften, as a result of which the cold casting mold can be plasticized or plastically deformed. By blowing in compressed air in a targeted manner, the soft, malleable cold casting mold can be detached from the preferably already cured mixing compound (at green body hardness).

Advantageously, the thermal and/or thermochemical decomposition of the cold casting mold is carried out in a sintering furnace, wherein the cold casting mold is placed in the sintering furnace together with the mixing compound located therein.

An optional method step provides for the mixing compound to be pre-sintered before the actual sintering, in particular at a temperature in a temperature range from 650° C. to 1300° C., in order to remove the binder components before the molded part is compacted to final hardness.

The thermal and/or thermochemical decomposition can then be continued completely and/or at high temperatures in a sintering temperature range from 900° C. to 2500° C., so that a residue-free or at least almost residue-free dissolution of the cold casting mold is made possible by the action of heat.

According to a method variant, the decomposition of the cold casting mold is carried out thermally under oxygen-free conditions, in particular pyrolytically, or thermochemically with the supply of oxygen, in particular by combustion.

During the pyrolytic decomposition of the cold casting mold under oxygen-free conditions, the cold casting mold is placed in a sintering furnace together with the mixing compound contained therein, which enables sintering under vacuum and/or (low-oxygen or oxygen-free) protective atmosphere. This method variant is particularly suitable for producing metallic, dental molded parts, for example made of a CrCo alloy, in order to avoid damage to the molded part due to oxidation.

In particular to obtain ceramic molded parts, in particular dental molded parts, according to another method variant, however, decomposition of the cold casting mold with supply of oxygen by combustion is also possible.

Finally, according to a method variant, the cold casting mold, in particular the walls of the cold casting mold delimiting the cavity, can be coated using a coating agent before the filling with the mixing compound in order to avoid a frictional and/or materially-bonded connection between the cold casting mold and the mixing compound.

It is conceivable to immerse the cold casting mold in a basin having an organic, oily liquid such as petroleum, or alternatively to rinse it using an organic, oily liquid such as petroleum, shortly before or immediately before it is filled with the mixing compound. In this way, a heat-resistant protective layer can be formed in a simple and uncomplicated manner between the walls of the cold casting mold delimiting the cavity and the mixing compound, without closing the first and/or the second opening.

Filigree, thin-walled structures are often required in dental molded parts such as crowns, bridges, dental implant parts, and/or prostheses. High sintering temperatures are required especially for the production of dental molded parts made of ceramic or metal. In order to avoid damage to the molded part due to the thermal expansion of the cold casting mold, the linear, thermal expansion of the cold casting mold is advantageously at most 10%, preferably at most 3%, and particularly preferably at most 0.8% in relation to its initial geometry, wherein the maximum thermal expansion of the cold casting mold is reached at a temperature of less than or equal to 240° C., preferably less than or equal to 200° C., more preferably less than or equal to 150° C., and particularly preferably less than or equal to 100° C. Preferably, the coefficient of thermal expansion (CTE value) of the mixing compound can be adjusted, taking into consideration the respective CTE values of the metal, ceramic, or glass-ceramic powder used, by way of the proportions of polyelectrolytes and binders (polymers) and the CTE value of the cold casting mold, so that cold casting mold and mixing compound are subject to a similar or identical thermal expansion. Additionally or alternatively, the mechanical stability of the mixing compound (in the green body state) can be increased by increasing the proportion of binder.

In order to achieve the dimensional accuracy of the cold casting mold required for dental molded parts, even with pressure filling methods, the cold casting mold has a Shore hardness of at least 15 according to Shore A and/or of at least 10 according to Shore D and a modulus of elasticity of at least 5 MPa. The walls delimiting the cavity of the cold casting mold preferably each have a wall thickness of at least 0.01 mm. The Shore hardness is a material parameter for elastomers and plastics and is defined in the standards DIN EN ISO 868, DIN ISO 7619-1, and ASTM D2240-00. The modulus of elasticity, also referred to as tensile modulus or elasticity modulus, is defined for plastics in particular according to DIN EN ISO 527-1:2019-12.

An exemplary prototype of a cold casting mold according to the invention, suitable for the production of dental molded parts, was produced according to a stereolithography 3D printing method having the following PHYSICAL PROPERTIES:

| ASTM | | | | | |
|---|---|---|---|---|---|
| Method | Property Description | Metric | | Imperial | |
| D638M | Tensile Modulus | 2100 | MPa | 305,000 | psi |
| D638M | Ultimate Strength | 44.9 | MPa | 6,500 | psi |
| D638M | Elongation at fracture | 6.1% | | 6.1% | |
| D790M | Flexural strength | 74.3 | MPa | 10,770 | psi |
| D790M | Flexural Modulus | 2200 | MPa | 329,000 | psi |
| D224 | Hardness (Shore D) | 85 | | 85 | |
| D256A | Izod impact strength | 0.23 | J/cm | 0.46 | ft lb/in |
| D570-98 | Water absorption | 0.7% | | 0.7% | |
| D648 | HPT @ 0.46 MPa (66 psi) | 59° | C. | 138° | F. |
| D648 | HPT @ 1.82 MPa (264 psi) | 50° | C. | 122° | F. |

### DESCRIPTION OF THE SEVERAL VIEWS OF THE DRAWINGS

Further details, features, feature (sub-)combinations, advantages, and effects on the basis of the invention will be apparent from the following description of a preferred exemplary embodiment and from the drawings. In the figures

FIG. 1 shows a flow chart of an exemplary sequence of the method according to the invention for producing a molded part, here using the example of a dental molded part,

FIG. 2 shows a schematic representation of a cold casting mold whose cavity corresponds to the shape of a denture,

FIG. 3 shows a schematic perspective representation of an embodiment of a cold casting mold having a filling channel and a compensating volume,

FIG. 4 shows a sectional view of the cold casting mold from FIG. 3,

FIG. 5 shows a schematic perspective representation of a second exemplary embodiment of a cold casting mold according to the invention having two filling channels,

FIG. 6 shows a schematic perspective representation of a molded part which was produced using a cold casting mold according to the invention.

The figures are merely of an exemplary nature and are used only to understand the invention. The same elements are provided with the same reference numerals and are therefore usually only described once.

### DETAILED DESCRIPTION OF THE INVENTION

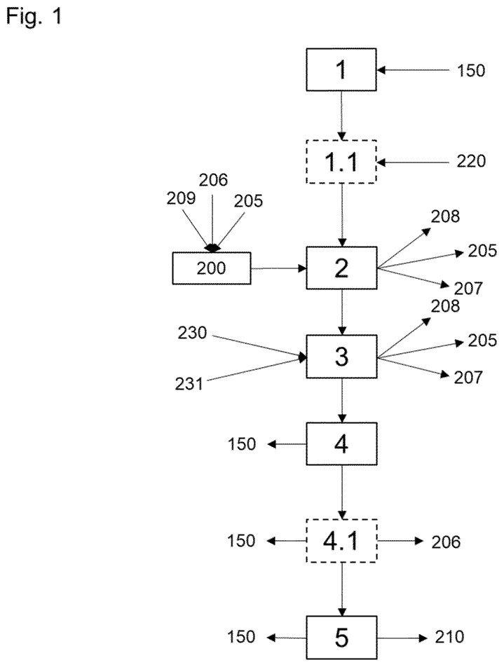

FIG. 1 shows a flow chart of an exemplary sequence of the method according to the invention for the production of a dental molded part 210. In this case, a cold casting mold 100 is first produced (1). The cold casting mold 100 is constructed by means of an additive material construction method, for example using a 3D printer, wherein the cold casting mold 100 is constructed having at least one opening 111, 112. A thermally and/or thermochemically decomposable plastic is preferably used as the starting material 150. Optionally, the cold casting mold 100 can be coated with a coating agent 220 before it is filled with the mixing compound 200 (1.1). Petroleum, for example, is suitable as the coating agent 220, wherein the cold casting mold 100 is preferably immersed in a basin containing petroleum. The cold casting mold 100 is then filled with the mixing compound 200 (2). Depending on the desired molded part 210, the mixing compound 200 comprises a ceramic or metallic powder 209, which is suitable for the production of dental shaped parts. The respective powder 209 is preferably mixed with a diluent 205, for example water or an organic solvent, to form a slurry or a pasty mass, admixed with a binder 206, and conditioned before use. The mixing compound 200 is filled into the cavity 110 of the cold casting mold 100 via the at least one opening 111, 112. Fluids 207 contained in the mixing compound 200, in particular the diluent 205 or air inclusions 208, can already escape via the at least one opening 111, 112 during the filling. After the filling, the mixing compound 200 cures or solidifies inside the cold casting mold 100, more precisely in its cavity 110 (3). In order to accelerate the curing or solidifying, the cold casting mold 100 is placed, for example, in a drying cabinet or climatic cabinet to set a desired ambient humidity of the environment, and heat 230 is applied, so that the liquid components of the mixing compound 200 dry or evaporate more quickly. Fluids 207, diluents 205, or air inclusions 208 can continue to escape via the at least one opening 111, 112. For the production of ceramic or metallic dental molded parts 210, the curing in the cold casting mold 100 is preferably carried out up to green body hardness. The stability of the green body can be achieved by the binder 206 used.

After the curing or solidifying, the cold casting mold 100, together with the cured mixing compound 200 located therein, is preferably initially softened in a sintering furnace at a temperature in a range from 35° C. to 300° C. and can, for example, be “inflated” by blowing in compressed air and detached from the mixing compound 200.

The cold casting mold 100 is expediently decomposed thermally or thermochemically (4) before or while the mixing compound 200 cures to final hardness. For this purpose, thermal decomposition or pyrolysis in the absence of oxygen or thermochemical decomposition or combustion with oxygen of the cold casting mold 100 is initiated in a sintering furnace at a temperature in a temperature range from 200° C. to 650° C., at which the starting material 150 is completely or almost completely dissolved. At a temperature in a temperature range from 650° C. to 1300° C., the mixing compound 200 can optionally be pre-sintered (4.1), wherein the binder 206 evaporates. During the ultimate final or dense sintering (5), the mixing compound 200 is compacted to final hardness at a temperature in a temperature range from 900° C. to 2500° C. and can be removed from the sintering furnace as a finished dental molded part 210. Any remnants of the cold casting mold 100 that are not yet completely decomposed are also decomposed during pre-sintering or final sintering.

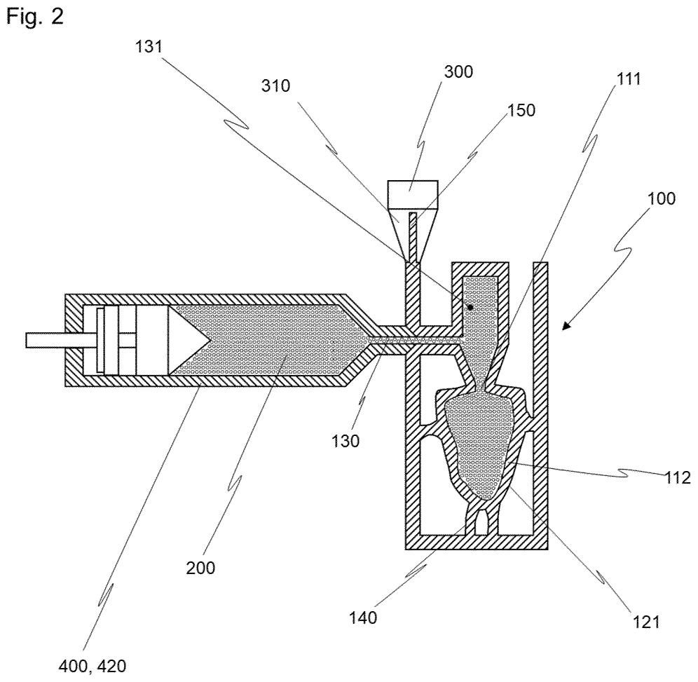

FIG. 2 shows an exemplary embodiment of the invention, in which the cold casting mold 100 has a cavity 110 which corresponds to the geometry of a dental molded part 210. Also indicated schematically in the figure is a pressure nozzle 310 of a 3D printer 300, by means of which the cold casting mold 100 is integrally constructed additively from the starting material 150. The cold casting mold 100 comprises a first opening 111 which connects to a filling channel 130 in a fluid-conducting manner via a compensating volume 131. The cavity 110 is filled with the mixing compound 200 via the filling channel 130 using a filling means 400, here by way of example an injection syringe 420. Fluids 207 contained in the mixing compound 200 or air inclusions 208 occurring during filling are discharged from the cavity 110 via a plurality of second openings 112. The second openings 112 are formed here as capillaries or pores in the external walls 121 and are therefore not visible to the naked eye. The large number of second openings 112 creates a porous or hygroscopic surface, which conducts fluids 207 or moisture contained in the mixing compound 200 out of the cavity to the external environment.

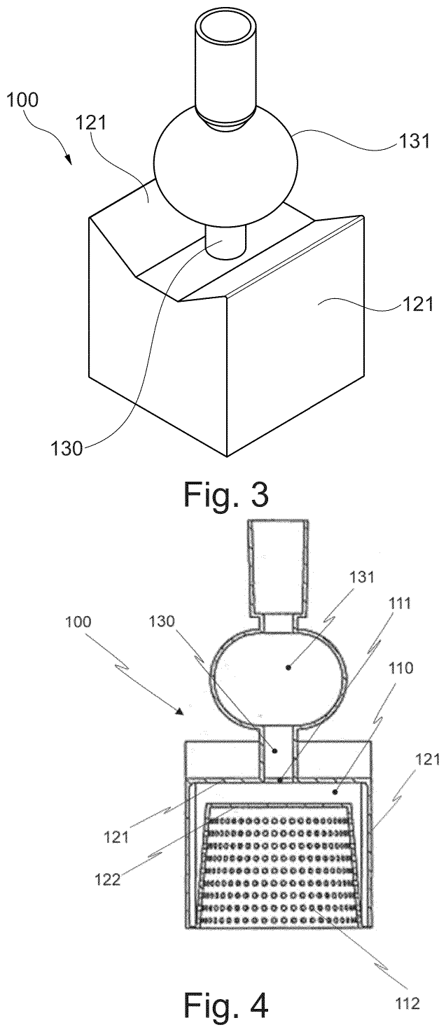

FIGS. 3 and 4 each show an exemplary embodiment of a cold casting mold 100, in a schematic perspective view and in a sectional view, respectively. The cold casting mold 100 is embodied here, for example, in the form of a test specimen, the cavity 110 of which has geometric properties typical for dental molded parts 210, which result in wall thicknesses of the molded part 210 in a range from 0.30 mm to 10 mm. The cavity 110 of the cold casting mold 100 is delimited by the external walls 121 and the internal walls 122 of the cold casting mold 100, so that the finished molded part 210, for example a crown, has an internal cavity 211 (see FIG. 6) which, for example, corresponds to the shape of an abutment, as a result of which the crown can be placed on the abutment. For this purpose, the internal walls 122 form a cylindrical or truncated cone shape. A first opening 111 opens into the cavity 110 and penetrates one of the external walls 121, which are occlusal with respect to the dental molded part 210. The cavity 110 is filled with the mixing compound 200 via the first opening 111. The internal walls 122 are penetrated using a plurality of second openings 112 which, for example, allow fluids 205, 207 and/or air inclusions 208 contained in the mixing compound 200 to escape already during the filling. After the filling, fluids 205, 207, 208 can optionally also escape via the first opening 111. The plurality of second openings 112 can, as shown here by way of example, penetrate an inner lateral surface of the cavity 110 like a sieve. Alternatively, the plurality of second openings 112 could be embodied in the form of pores and/or capillaries and form a porous and/or hygroscopic surface.

A filling channel 130 having a compensating volume 131 adjoins the first opening 111 in a fluid-conducting manner. Filling means 400, for example injection syringes 420, in particular low-pressure injection syringes (see FIG. 2) or supply lines, such as hoses 410 can be connected to the filling channel 130 to facilitate the filling of the cavity 110 with mixing compound 200. The compensating volume 131 is used as a type of reservoir for the mixing compound 200, so that the volume loss of fluids 205, 207, 208 escaping through the second openings 112 can be compensated for by means of the mixing compound 200 stored in the compensating volume 131. In the exemplary embodiment shown, the cold casting mold 100 is produced integrally with the filling channel 130 and the compensating volume 131.

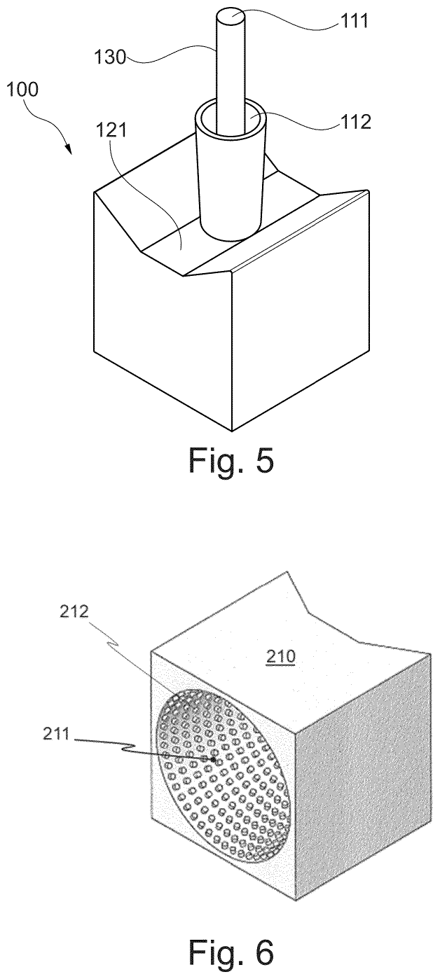

FIG. 5 shows a schematic perspective representation of a second exemplary embodiment of a cold casting mold 100 according to the invention. The cold casting mold 100 corresponds to the first exemplary embodiment shown in FIGS. 1 and 2, with the exception that the filling channel 130 is formed without the (optional) compensating volume 131 and a channel-like second opening 112 opens integrally into the occlusal external wall 121. The filling channel 130 can optionally be implemented integrally or also as an additional part of the cold casting mold 100 and opens with its first opening 111 into the cavity 110. In this variant, the first opening 111 penetrates the second opening 112 concentrically. If required, a separate compensating volume 131 can be connected to the filling channel 130, in particular as part of a filling means 400.

The mixing compound 200 cured to the final hardness required for dental molded parts 210 can be seen in FIG. 6 as a finished molded part 210, which was produced using the cold casting mold 100 designed as a test specimen. The molded part 210 has wall thicknesses in a range from 0.3 mm to 10 mm. A lower, apical section of the molded part 210 is formed having a recess 211, the shape of which corresponds to the shape of an abutment for placing a dental molded part 210, for example a crown. The inward facing walls of the recess 211 are provided with a nubby surface 212 due to the plurality of second openings 112 which penetrate the internal walls 122 of the cold casting mold 100 in a sieve-like structure (see FIG. 4). The nubby surface 212 improves the hold between the dental molded part 210, for example a crown and, for example, an abutment.

### LIST OF REFERENCE SIGNS

100 cold casting mold
110 cavity or tool shape
111 first opening
112 second opening
120 wall
121 external wall
122 internal wall
130 filling channel
131 compensating volume
140 support structure
150 starting material
200 mixing compound
205 diluent
206 binder
207 fluids
208 air inclusions
209 powder
210 molded part
211 recess
220 coating agent
230 heat/ambient humidity
231 light
300 3D printer
310 pressure nozzle
400 filling means
420 injection syringe, in particular low-pressure injection syringe

### Method Steps:

1 producing a cold casting mold
1.1 coating the cold coasting mold
2 filling the cold casting mold with mixing compound
3 curing and/or solidifying the mixing compound in the cold casting mold
4 thermally or thermochemically decomposing the cold casting mold
4.1 pre-sintering
5 sintering/final sintering

1. A method for producing molded parts (210) from a sinterable mixing compound (200) using a cold casting mold (100) having a cavity (110) that corresponds geometrically to the molded part and at least one opening (111, 112) opening into the cavity (110), the method comprising the following method steps:
(1) producing the cold casting mold (100) by means of an additive material construction method from a starting material (150), wherein the cavity (110) is created on the basis of a digital data set, based on a three-dimensional model of the oral cavity of a patient,
(2) filling the cavity (110) of the cold casting mold (100) via the at least one opening (111, 112) with the sinterable mixing compound (200),
(3) curing or solidifying the sinterable mixing compound (200) in the cavity (110) of the cold casting mold (100),
wherein gases or liquids contained or enclosed in the sinterable mixing compound (200) are discharged from the cavity (110) via the at least one opening (111, 112),
(4) thermally or thermochemically decomposing the cold casting mold (100) at a temperature in a temperature range from 200° C. to 2500° C.,
(5) sintering the sinterable mixing compound (200) to final hardness at a temperature in a temperature range from 900° C. to 2500° C. until a molded part (210) is obtained.

2. The method as claimed in claim 1,
characterized in that
the mixing compound (200) is provided as a slurry or pasty mass and comprises a diluent (205), wherein the mixing compound (200) cures or solidifies in the cavity (110) of the cold casting mold (100) by drying and a liquid component or moisture content of the mixing compound (200) is discharged by means of the at least one opening (111, 112) from the cold casting mold (100).

3. The method as claimed in claim 2,
characterized in that
the cold casting mold (100) is additively constructed having at least one first opening (111) opening into the cavity (110) or leading out of the cavity (110) and having at least one second opening (112) opening into the cavity (110) or leading out of the cavity (110), wherein the cavity (110) of the cold casting mold (100) is filled via the first opening (111) and gases contained or enclosed in the sinterable mixing compound (200) are discharged via the second opening (112) from the cavity (110).

4. The method as claimed in claim 3,
characterized in that
at least one wall (120) of the cold casting mold (100) delimiting the cavity (110) is additively constructed completely or in regions having a plurality of second openings (112), which open into the cavity (110) or lead out of the cavity (110) and penetrate this wall (120), for discharging gases.

5. The method as claimed in claim 1,
characterized in that
the mixing compound (200) cures or solidifies in the cavity (110) of the cold casting mold (100) under the action of heat, wherein the cold casting mold (100) filled with the mixing compound (200) is placed in a drying cabinet, climatic cabinet, or a sintering furnace and a temperature in a temperature range from 30° C. to 120° C. or humidity in a range from 1% to 50% is set.

6. The method as claimed in claim 1,
characterized in that
the digital data set, which is based on a three-dimensional model of the oral cavity of a patient, for the geometric design of the cavity (110) of the cold casting mold (100) comprises a sintering-related or curing-related volume shrinkage of the mixing compound (200).

7. The method as claimed in claim 1,
characterized in that
an organic material, is used as the starting material (150) for additively constructing the cold casting mold (100), so that the cold casting mold (100) can be plasticized or thermally or thermochemically decomposed.

8. The method as claimed in claim 1,
characterized in that
the mixing compound (200) comprises a metal powder (209) or a ceramic powder (209), or a zirconium oxide powder or a glass ceramic powder and a binder (206).

9. The method as claimed in claim 8,
characterized in that
the melting point or the decomposition temperature of the cold casting mold (100) is below the melting point or the decomposition temperature of the binder (206).

10. The method as claimed in claim 9,
characterized in that
the mixing compound (200) in the cavity (110) of the cold casting mold (100) cures to green body hardness before the decomposition of the cold casting mold (100) is initiated or completely carried out.

11. The method as claimed in claim 10,
characterized in that
the decomposition of the cold casting mold (100) is initiated or carried out completely by the action of heat at a temperature in a temperature range from 200° C. to 650° C., before the mixing compound (200) is sintered to final hardness.

12. The method as claimed in claim 11,
characterized in that
the melting point or the decomposition temperature of the cold casting mold (100) is below the sintering temperature of the mixing compound (200).

13. The method as claimed in claim 8,
characterized in that
the thermal or thermochemical decomposition of the cold casting mold (100) is carried out in a sintering furnace, wherein the cold casting mold (100) is placed in the sintering furnace together with the mixing compound (200) located therein.

14. The method as claimed in claim 13,
characterized in that
the decomposition of the cold casting mold (100) is carried out thermally under oxygen-free conditions or thermochemically with a supply of oxygen.

15. The method as claimed in claim 1,
characterized in that
the cold casting mold (100) is coated using a coating agent (220) before the filling with the mixing compound (200) in order to avoid a frictional or materially-bonded connection between the cold casting mold (100) and the mixing compound (200).

16. The method as claimed in claim 1 wherein the cold casting mold (100) is produced by a 3D printing method using a 3D printer (300).

17. The method as claimed in claim 7 wherein the organic material is an organic polymer or a wax or a plastic, having a melting point or a decomposition temperature in a temperature range from 40° C. to 300° C.

18. The method as claimed in claim 8 wherein the mixing compound (200) comprises a CrCo powder or a zirconium oxide powder or a glass ceramic powder or a lithium disilicate powder.

19. The method as claimed in claim 14 wherein the decomposition of the cold casting mold (100) is carried out thermally under oxygen-free conditions pyrolytically or thermochemically with a supply of oxygen by combustion.

20. The method as claimed in claim 15 wherein the interior walls (120) of the cold casting mold (100) delimiting the cavity (110) are coated using the coating agent (220) before filling with the mixing compound (200).
